(19) United States
(12) Patent Application Publication
(10) Pub. No.: US 2015/0271469 A1
(43) Pub. Date: Sep. 24, 2015

(54) IMAGE SYNCHRONIZATION METHOD FOR CAMERAS AND ELECTRONIC APPARATUS WITH CAMERAS

(71) Applicant: HTC Corporation, Taoyuan City (TW)

(72) Inventors: Chung-Hsien HSIEH, Taoyuan City (TW); Ming-Che KANG, Taoyuan City (TW)

(21) Appl. No.: 14/615,432

(22) Filed: Feb. 6, 2015

Related U.S. Application Data
(60) Provisional application No. 61/955,219, filed on Mar. 19, 2014.

(51) Int. Cl. H04N 13/02; H04N 1/21

(52) U.S. Cl. CPC H04N 13/0207; H04N 1/2112; H04N 1/2195

(57) ABSTRACT

A method, suitable for an electronic apparatus with a first camera and a second camera, is disclosed. The method includes following steps. A series of first frames generated by the first camera is stored into a first queue and a series of second frames generated by the second camera is stored into a second queue. In response to the first camera is triggered to capture a first image, one of the first frames recorded with a first timestamp is dumped as the first image. It searches the second queue for one of the second frames recorded with a second timestamp corresponding to the first timestamp. The corresponding one of the second frames is dumped as a second image.

### CROSS-REFERENCE TO RELATED APPLICATION

This application claims the priority benefit of U.S. Provisional Application Ser. No. 61/955,219, filed Mar. 19, 2014, the full disclosures of which are incorporated herein by reference.

### FIELD OF INVENTION

The disclosure relates to a photography method/device. More particularly, the disclosure relates to a method of synchronizing images captured by different cameras.

### BACKGROUND

Photography used to be a professional job, because it requires much knowledge in order to determine suitable configurations (e.g., controlling an exposure time, a white balance, a focal distance) for shooting a photo properly. As complexity of manual configurations of photography has increased, required operations and background knowledge of user have increased.

Stereoscopic image is based on the principle of human vision with two eyes. One way to establish a stereoscopic image is utilizing two cameras separated by a certain gap to capture two images, which correspond to the same objects in a scene from slightly different positions/angles. The X-dimensional information and the Y-dimensional information of the objects in the scene can be obtained from one image. For the Z-dimensional information, these two images are transferred to a processor which calculates the Z-dimensional information (i.e., depth information) of the objects to the scene. The depth information is important and necessary for applications such as the three-dimensional (3D) vision, the object recognition, the image processing, the image motion detection, etc.

In order to perform further image processes (e.g. the depth computation or other three-dimensional applications), a pair of images captured by two cameras is required. In addition, the pair of images must be captured by two cameras synchronously. Otherwise, any mismatch between two images may induce errors (e.g., ghost shadows) in the image processes.

### SUMMARY

An aspect of the disclosure is to provide a method, suitable for an electronic apparatus with a first camera and a second camera, is disclosed. The method includes following steps. A series of first frames generated by the first camera is stored into a first queue and a series of second frames generated by the second camera is stored into a second queue. In response to the first camera is triggered to capture a first image, one of the first frames recorded with a first timestamp is dumped as the first image. It searches the second queue for one of the second frames recorded with a second timestamp corresponding to the first timestamp. The corresponding one of the second frames is dumped as a second image.

Another aspect of the disclosure is to provide an electronic apparatus, which includes a first camera, a second camera, a processing module and a non-transitory computer-readable medium. The first camera is configured for sequentially generating a series of first frames. The first frames are temporarily stored in a first queue. The second camera is configured for sequentially generating a series of second frames. The second frames are temporarily stored in a second queue. The processing module is coupled with the first camera and the second camera. The non-transitory computer-readable medium comprising one or more sequences of instructions to be executed by the processing module for performing a method. The method includes following steps. In response to the first camera is triggered to capture a first image, one of the first frames recorded with a first timestamp is dumped as the first image. It searches the second queue for one of the second frames recorded with a second timestamp corresponding to the first timestamp. The corresponding one of the second frames is dumped as a second image.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a view diagram an electronic apparatus according to an embodiment of the disclosure.

FIG. 2 is a functional block diagram illustrating the electronic apparatus shown in FIG. 1.

FIG. 3 is a flow chart diagram illustrating a method for ensuring the time-synchronization between the images captured by two cameras.

FIG. 4A and FIG. 4B are schematic diagrams illustrating contents of the first queue and the second queue in a first operational example according to an embodiment of the disclosure.

FIG. 5 is a schematic diagram illustrating contents of the first queue and the second queue in a second operational example according to an embodiment of the disclosure.

FIG. 6 is a schematic diagram illustrating contents of the first queue and the second queue in a third operational example according to an embodiment of the disclosure.

FIG. 7 is a schematic diagram illustrating contents of the first queue and the second queue in a fourth operational example according to an embodiment of the disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

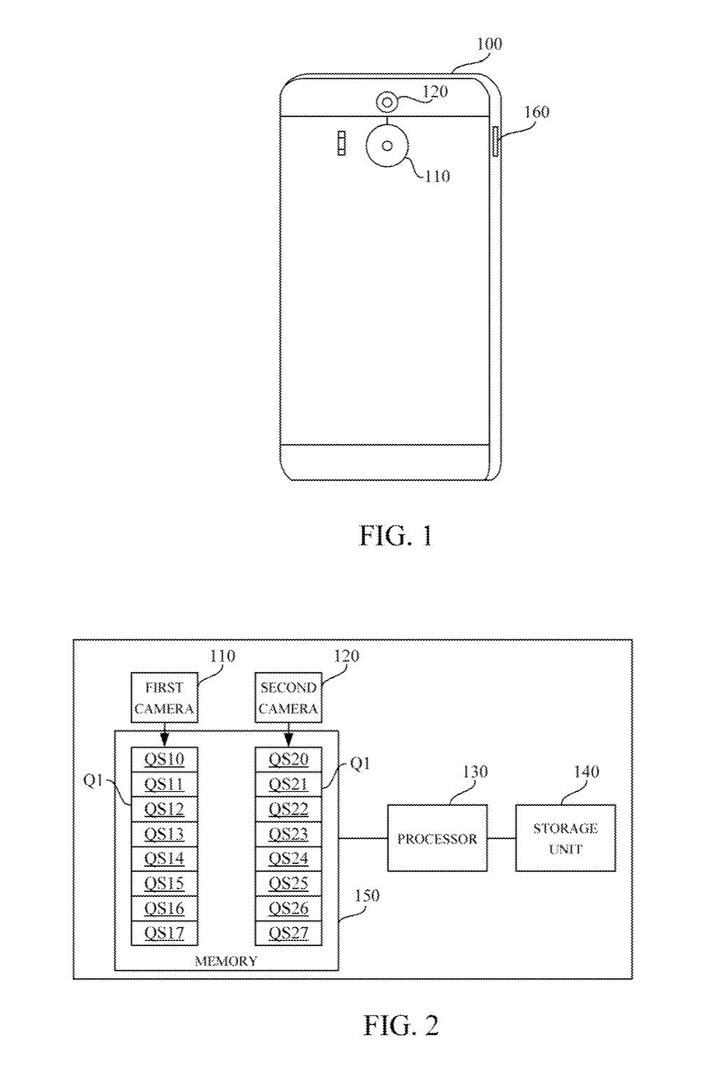

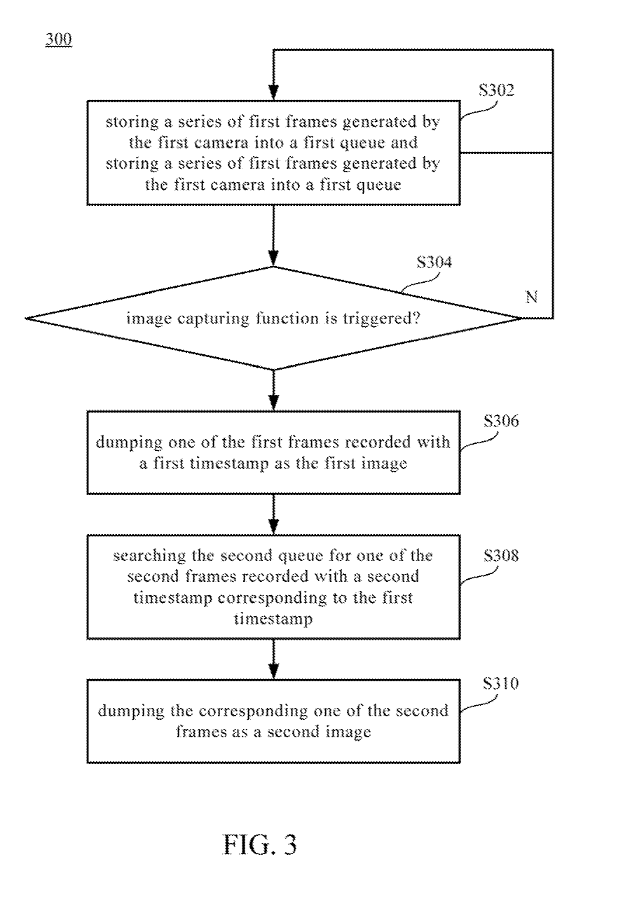

Reference is made to FIG. 1 and FIG. 2, FIG. 1 is a view diagram an electronic apparatus 100 according to an embodiment of the disclosure. FIG. 2 is a functional block diagram illustrating the electronic apparatus 100 shown in FIG. 1. As shown in the figures, the electronic apparatus 100 in the embodiment includes a first camera 110, a second camera 120, a processor 130, a storage unit 140 and a memory 150. The disclosure provides a method to ensure a pair of images captured by two individual cameras (i.e., the first camera 110 and the second camera 120) is time-synchronized, e.g., captured at the same time or approximately the same time.

In this embodiment, there is a function key 160 disposed on the casing of the electronic apparatus 100. The user is able press the function key 150 to activate an image capturing function of the first camera 110 and the second camera 120. In other embodiments, the user is able to trigger the image capturing function by operating on a touch panel, saying a voice command, moving the electronic apparatus 100 along a specific pattern or via any equivalent triggering manners.

In the embodiment shown in FIG. 1, the first camera 110 is a main camera in a dual camera configuration and the second camera 120 is a subordinate camera (i.e., sub-camera) in the dual camera configuration. As shown in FIG. 1, the first camera 110 and the second camera 120 within the dual camera configuration in this embodiment are both disposed on the same surface (e.g., the back side) of the electronic apparatus 100 and gapped by an interaxial distance. The first camera 110 is configured for pointing in a direction and sensing a first image corresponding to a scene. The second camera 120 point in the same direction and sensing a second image substantially corresponding to the same scene as the first camera 110 does. In other words, the first camera 110 and the second camera 120 are capable to capture a pair of images to the same scene from slight different viewing positions (due to the interaxial distance), such that the pair of images can be utilized in computation of depth information, simulation or recovering of three-dimensional (3D) vision, parallax (2.5D) image processing, object recognition, motion detection or any other applications.

In some embodiment, the first camera 110 and the second camera 120 adopt the same model of cameras. In this embodiment shown in FIG. 1A, the first camera 110 and the second camera 120 of the dual camera configuration adopt different models of cameras. In general, the first camera 110, which is the main camera, may have better optical performances, and the first image sensed by the first camera 110 is usually recorded as a captured image. On the other hand, the second camera 120, which is the subordinate camera, may have the same or relative lower optical performances, and the second image sensed by the second camera 120 is usually utilized as auxiliary data or supplemental data.

However, the first camera 110 and the second camera 120 in the disclosure are not limited to be the main camera and the subordinate camera in the dual camera configuration shown in FIG. 1. The disclosure is suitable to any electronic apparatus 100 with two cameras for capturing a pair of images synchronously.

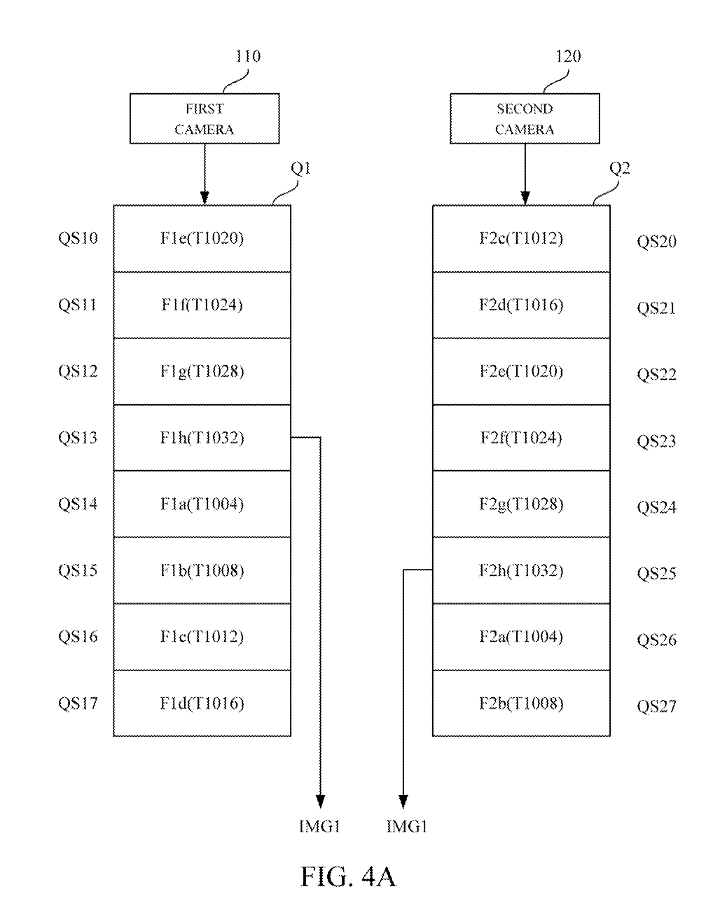

Reference is also made to FIG. 3, which is a flow chart diagram illustrating a method 300, suitable for the electronic apparatus 100 including the first camera 110 and the second camera 120, for ensuring the time-synchronization between the images captured by two cameras. As shown in FIG. 3, the method 300 executes the step S302 for storing a series of first frames generated by the first camera 110 into a first queue Q1 and a series of second frames generated by the second camera 120 into a second queue Q2.

The electronic apparatus 100 in FIG. 1 and FIG. 2 further includes a non-transitory computer-readable medium includes one or more sequences of instructions to be executed by the processor 130 for performing the method 300 explained in the followings.

On traditional cameras, after the user press a triggering key (e.g., a shutter button or a shooting function key on a touch panel), an image sensor within the traditional camera is activated to capture an image. A shutter reaction time includes setting up the image sensor, collecting data by the image sensor and dumping the data as a newly captured image. It may take about 1˜3 seconds to take one shot. Shooting a series of images in a short period (e.g., the boost shooting mode) is impossible to the traditional cameras.

In order to boost the shutter reaction speed (i.e., reduce the shutter reaction time), when a photo-related function is launched, the first camera 110 continuously and periodically generate a series of first frames, and the second camera 110 continuously and periodically generate a series of second frames. For example, the first camera 110 generates 30 frames every one second (e.g., 30 fps). The first frames and the second frames are sequentially stored into the first queue Q1 and the second queue Q2 respectively.

As the embodiment shown in FIG. 2, the first queue Q1 and the second queue Q2 are formed in the memory 150 of the electronic apparatus 100. In some embodiments, each of the first queue Q1 and the second queue Q2 a ring buffer (also known as circular buffer), which is a data structure that uses a single, fixed-size buffer as if it were connected end-to-end. This ring structure is suitable for buffering data streams. Each of the first queue Q1 and the second queue Q2 has several slots. For demonstration, the first queue Q1 illustrated in FIG. 2 includes eight slots QS10˜QS17, and the second queue Q2 illustrated in FIG. 2 includes eight slots QS20˜QS27, but the disclosure is not limited to specific amount of slots.

Each of the slots QS10˜QS17 of the first queue Q1 holds one of the first frames generated by the first camera 110. When the photo-related function is launched, during the step S302, the first camera 110 keep generating first frames respectively at different time spots and sequentially storing the first frames into the first queue Q1. Each of the first frames is recorded with one individual timestamp respectively indicating a time spot when the first frame is generated.

Each of the slots QS20˜QS27 of the second queue Q2 holds one of the second frames generated by the second camera 120. When the photo-related function is launched, during the step S302, the second camera 120 keep generating second frames respectively at different time spots and sequentially storing the second frames into the second queue Q2. Each of the second frames is recorded with one individual timestamp respectively indicating a time spot when the second frame is generated.

In addition, the first queue Q1 and the second queue Q2 are dynamically updated/refreshed during the photo related function is launched, if there is a newly incoming first frame and the first queue is already full, the newly incoming first frame will overwrite into the slot in the first queue with the oldest first frame in it. Therefore, the first queue Q1 and the second queue Q2 are able to dynamically keep the latest frames.

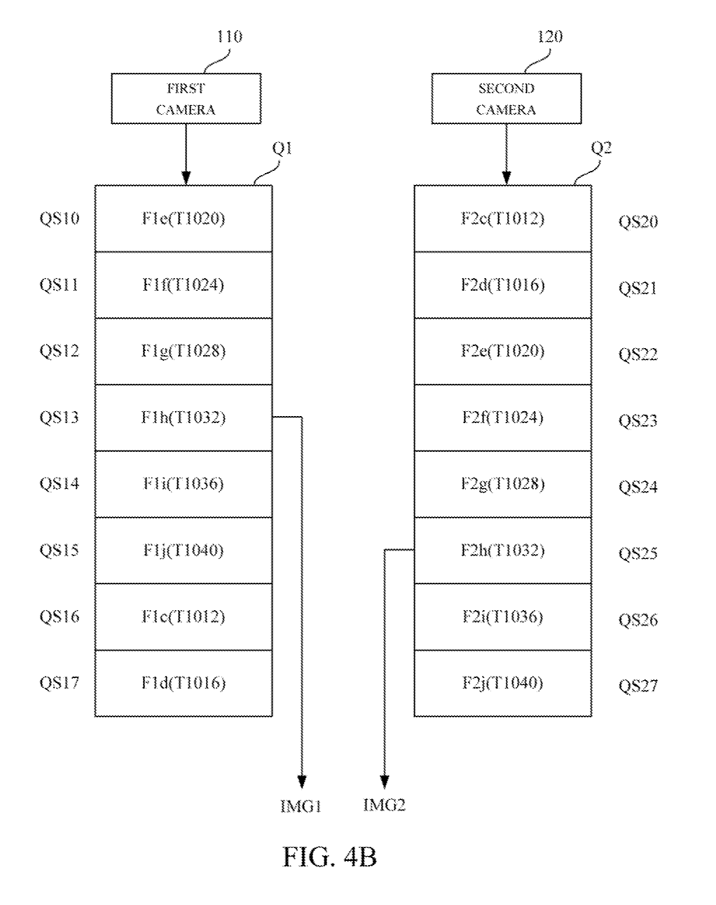

Reference is also made to FIG. 4A and FIG. 4B are schematic diagrams illustrating contents of the first queue Q1 and the second queue Q2 in a first operational example according to an embodiment of the disclosure.

As shown in FIG. 4A, the first frames F1a˜F1h in a series are stored in the first queue Q1. The first frame F1a is recorded with a timestamp T1004, which indicates the first frame F1a is generated at 1004^{th} microsecond according to a system clock. The first frame F1b is recorded with another timestamp T1008, which indicates the first frame F1b is generated at 1008^{th} microsecond according to the system clock. The first frame F1c is recorded with another timestamp T1012, which indicates the first frame F1c is generated at 1012^{th} microsecond according to the system clock, and so on.

In the example, as shown in FIG. 4A, one first frame and the following first frame are gapped by four microseconds. It means, in this example, the first camera 110 generates one new frame every four microseconds (i.e., 15 frames per second, 15 fps), and the second camera 120 also generates at 15 fps.

On the other hand, the second frames F2a˜F2h in a series are stored in the second queue Q2. The second frame F2a is recorded with a timestamp T1004, which indicates the second frame F2a is generated at 1004^{th} microsecond according to the system clock. The second frame F2b is recorded with another timestamp T1008, which indicates the second frame F2b is generated at 1008^{th} microsecond according to the system clock. The second frame F2c is recorded with another timestamp T1012, which indicates the second frame F2c is generated at 1012^{th} microsecond according to the system clock, and so on.

The method 300 executes the step S304 for determining whether the image capturing function is triggered. When an image capturing function is triggered (e.g., the user presses down the function key 160 or by any equivalent triggering manners), the first camera 110 is triggered to capture a first image IMG1, and also the second camera 120 is triggered to capture a second image IMG2 (as shown in FIG. 4B) paired with the first image IMG1 in time-synchronization.

In the disclosure, the first camera 110 and the second camera 120 are not required to set up, shoot, collect data, output data as the output image after the image capturing function is activated. As shown in FIG. 3 and FIG. 4A, in response to the first camera 110 is triggered to capture a first image IMG1 (i.e., the image capturing function is triggered), step S306 is executed for dumping one of the first frames F1a˜F1h with a first timestamp in the first queue Q1 as the first image IMG1. As shown in FIG. 4A, there are eight first frames F1a˜F1h record with timestamps T1004, T1008, T1012, T1016, T1020, T1024, T1028 and T1032. During the step S306 in the embodiment, the latest first frame F1h recorded with the latest timestamp T1032 (i.e., the first timestamp in this example is T1032) is dumped as the first image IMG1. Therefore, the first frame F1h stored in the slot QS13 in the first queue is dumped as the first image IMG1, In some embodiment, the first image IMG1 is stored into the storage unit 140 by the processor 130.

Afterward, the method executes step S308 for searching the second queue Q2 for one of the second frames F2a˜F2h recorded with a second timestamp corresponding to the first timestamp (T1032). In the embodiment, the step S308 is executed to search for one of the second frames F2a˜F2h in the second queue Q2 with the second timestamp most adjacent to the first timestamp (T1032). The second timestamp (T1032) of the second frame F2h is most adjacent to the first timestamp of the first frame F1h.

Therefore, the method executes step S310 for dumping the corresponding second frame F2h recorded with the second timestamp (T1032) as the second image IMG2. In some embodiment, the second image IMG2 is stored into the storage unit 140 by the processor 130.

The first image IMG1 and the second image IMG2 are already existed as registered frames in the first queue Q1 and the second queue Q2 when the image capturing function is triggered, such that the first image IMG1 and the second image IMG2 can be generated faster. Therefore, the user experiences a fast reaction to the photo-shooting command (e.g., pressing down the function key 160) in real time.

As shown in FIG. 4A, the first frame F1h and the second image IMG2 are respectively stored in the 4^{th} slot QS13 in the first queue Q1 and the 6^{th} slot QS25 in the second queue Q2. Even when the first queue Q1 and the second queue Q2 are not time-synchronized to keep the frames within the same slot in the same order, the method 300 is able to locate the pair of the frames in the first queue Q1 and the second queue Q2 according to the timestamps recorded with each frames.

In aforesaid embodiment shown in FIG. 4A, it is an ideal case that the contents in the first queue Q1 and the second queue Q2 remains the same during the steps S306˜S310. However, the electronic apparatus 100 in practical applications may not execute the steps S306˜S310 fast enough before variation of the contents in the first queue Q1 and the second queue Q2, because the contents in the first queue Q1 and the second queue Q2 are dynamically updated/refreshed in a short period (e.g., every 4 microseconds in the embodiment).

FIG. 4B illustrates contents of the first queue Q1 and the second queue Q2 in a second operational example according to an embodiment of the disclosure. As shown in FIG. 4A and aforesaid embodiment, the first frame F1h recorded with the first timestamp (T1032) in the first queue Q1 is dumped as the first image IMG1. While performing computations (e.g., executing the step S306, storing the first image IMG1 and registering the first timestamp, etc) by the processor 130, the first camera 110 and the second camera 120 keep on generating new frames into the first queue Q1 and the second queue Q2, such that the first queue Q1 and the second queue Q2 at eight microseconds later are reflected as in FIG. 4B.

At the step S306 corresponding to FIG. 4A, the latest first frame F1h recorded with the first timestamp (T1032) is dumped as the first image IMG1. The first timestamp (T1032) is utilized by the step S308 for searching the second queue Q2. At the step S308 corresponding to FIG. 4B (e.g., executed by 8 microseconds later than FIG. 4A), the second frame F2h recorded with the second timestamp (T1032) is not the latest frame. There are newly incoming frames F2i and F2j stored in the second queue Q2. Based on the step S308 for searching corresponding to the first timestamp (T1032), the second frame F2h has the second timestamp (T1032) most adjacent to the first timestamp (T1032). Therefore, the second frame F2h is dumped as the second image IMG2 by the step S310.

In other words, the second image IMG2 is selected by the most synchronous frame from the second queue Q2 relative to the first image IMG1 according to information of the timestamp, not the latest one from the second queue Q2. The second image IMG2 captured by the second camera 120 is paired with the first image IMG1 captured by the first camera 110 in time-synchronization. A mismatch between two images due to the capturing time gap can be reduced by the method 300.

In aforesaid embodiments, the first queue Q1 and the second queue Q2 have the same amount of slots for registering the first/second frames. However, the disclosure is not limited thereto.

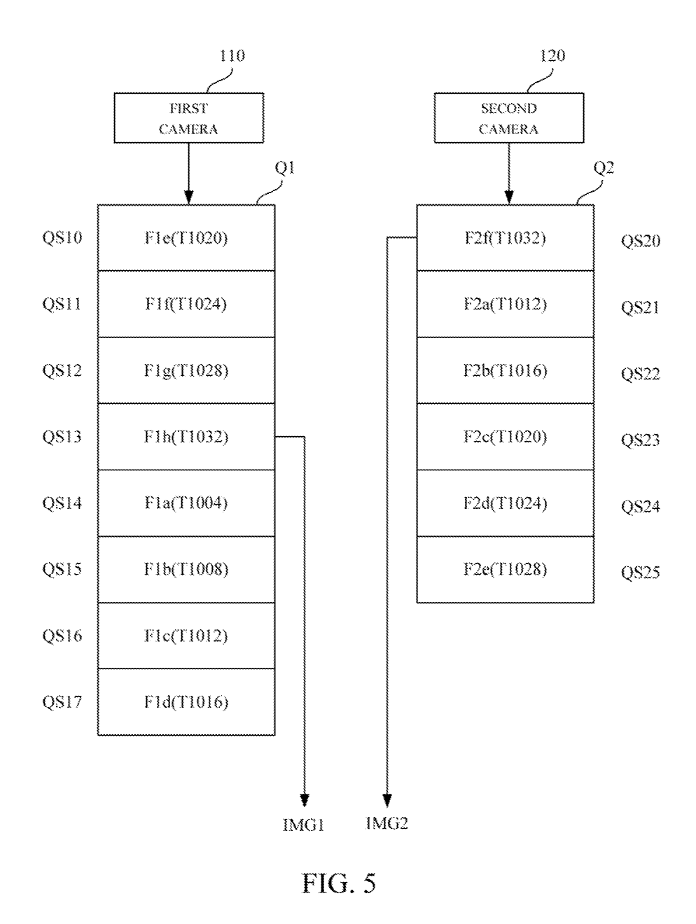

Reference is also made to FIG. 5 is a schematic diagram illustrating contents of the first queue Q1 and the second queue Q2 in a second operational example according to an embodiment of the disclosure. In the second operational example shown in FIG. 5, the first queue Q1 has eight slots and the second queue Q2 has six slots. The first queue Q1 and the second queue Q2 are mismatched in the amount of slots. Based on aforesaid method 300, the latest first frame F1h record with the first timestamp (T1032) is dumped as the first image IMG1 in the step S306. According to the searching result corresponding to the first timestamp (T1032), the second frame F2f record with the second timestamp (T1032) is dumped as the second image IMG2 in the step S310. The method 300 can still operates to locate the time-synchronized images from two cameras even when the first and the second queues Q1 and Q2 are mismatched in the amount of slots. Other details of the second operational example shown in FIG. 5 are explained already in aforesaid embodiments and not repeated here.

In aforesaid embodiments, the first camera 110 and the second camera 120 utilizes the same frame rate to update the first queue Q1 and the second queue Q2 in the step S302. However, the disclosure is not limited thereto.

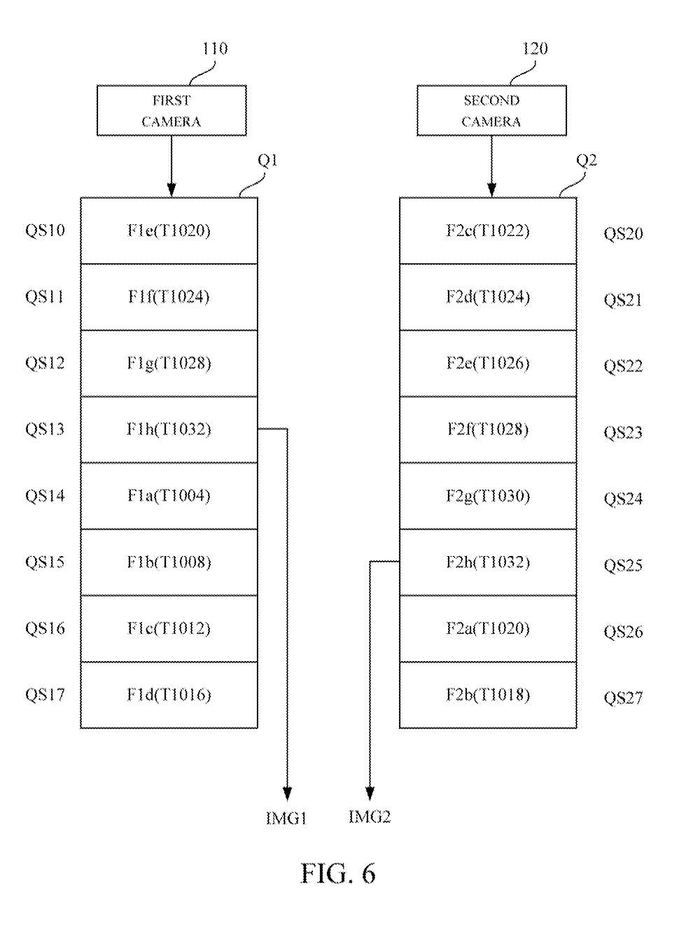

Reference is also made to FIG. 6 is a schematic diagram illustrating contents of the first queue Q1 and the second queue Q2 in a third operational example according to an embodiment of the disclosure. In the operational example shown in FIG. 6, the first camera 110 update the first queue Q1 every four microseconds (15 fps) and the second camera 120 update the second queue Q2 every two microseconds (30 fps). In this case, the first image IMG1 is dumped from the first frame F1h recorded with the first timestamp (T1032). Therefore, the second frame F2h recorded with the second timestamp (T1032) is dumped as the second image IMG2. The method 300 can still operates to locate the time-synchronized images from two cameras even when the first and the second queues Q1 and Q2 are mismatched in updating frame rates. Other details of the third operational example shown in FIG. 6 are explained already in aforesaid embodiments and not repeated here.

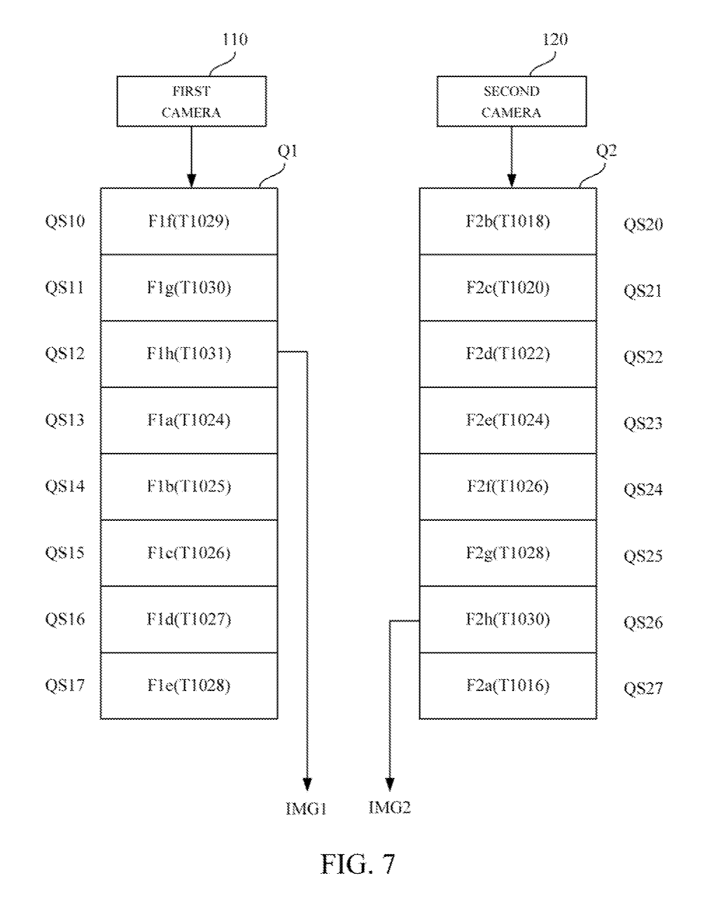

Reference is also made to FIG. 7 is a schematic diagram illustrating contents of the first queue Q1 and the second queue Q2 in a fourth operational example according to an embodiment of the disclosure. In the operational example shown in FIG. 7, the first camera 110 update the first queue Q1 every one microseconds (60 fps) and the second camera 120 update the second queue Q2 every two microseconds (30 fps).

In this case, the first image IMG1 is dumped from the first frame F1h recorded with the first timestamp (T1031), because the first timestamp (T1031) is the latest timestamp in this operational example. On the other hand, the second frame F2h recorded with the second timestamp (T1030) is dumped as the second image IMG2, because the second timestamp (T1030) of the timestamp in the second queue is the most adjacent one to the first timestamp (T1031). In this case, the second frame F2h might be not perfectly synchronized with the first frame F1h, due to a mismatch between the first timestamp (T1031) and the second timestamp (T1030). However, the method 300 can acquire the second frame F2h recorded with the second timestamp (T1030) most adjacent to the first frame F1h. Therefore, the first image IMG1 and the second image IMG2 are an optimal pair in time-synchronization between two queues Q1/Q2. Other details of the fourth operational example shown in FIG. 7 are explained already in aforesaid embodiments and not repeated here.

In this document, the term “coupled” may also be termed as “electrically coupled”, and the term “connected” may be termed as “electrically connected”. “coupled” and “connected” may also be used to indicate that two or more elements cooperate or interact with each other. It will be understood that, although the terms “first,” “second,” etc , may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, suitable for an electronic apparatus comprising a first camera and a second camera, the method comprising:
storing a series of first frames generated by the first camera into a first queue and a series of second frames generated by the second camera into a second queue;
in response to the first camera is triggered to capture a first image, dumping one of the first frames recorded with a first timestamp as the first image;
searching the second queue for one of the second frames recorded with a second timestamp corresponding to the first timestamp; and
dumping the corresponding one of the second frames as a second image.

2. The method of claim 1, wherein each of the first frames and the second frames is recorded with one individual timestamp respectively indicating a time spot when the first frame or the second frame is generated.

3. The method of claim 2, wherein the step of dumping the first image further comprises:
dumping the latest one of the first frames recorded with the latest timestamp in the first queue as the first image.

4. The method of claim 2, wherein the step of searching the second image further comprises:
searching for the second frame recorded with the second timestamp most adjacent to the first timestamp in the second queue.

5. The method of claim 1, wherein the second image captured by the second camera is paired with the first image captured by the first camera in time-synchronization.

6. The method of claim 1, wherein each of the first queue and the second queue is a ring buffer having a plurality of slots, each of the slots holds one of the first frames or the second frames.

7. The method of claim 1, wherein the first camera is a main camera in a dual camera configuration and the second camera is a subordinate camera in the dual camera configuration.

8. The method of claim 7, wherein the first camera and the second camera utilize asynchronous frame rates respectively for sensing the first frames and the second frames.

9. An electronic apparatus, comprising:
a processing module;
a first camera, configured for sequentially generating a series of first frames, the first frames being temporarily stored in a first queue;
a second camera, configured for sequentially generating a series of second frames, the second frames being temporarily stored in a second queue;
a non-transitory computer-readable medium comprising one or more sequences of instructions to be executed by the processing module for performing a method, comprising:
in response to the first camera is triggered to capture a first image, dumping one of the first frames recorded with a first timestamp as the first image;
searching the second queue for one of the second frames recorded with a second timestamp corresponding to the first timestamp; and
dumping the one of the second frames as a second image.

10. The electronic apparatus of claim 9, wherein each of the first frames and the second frames is recorded with one individual timestamp respectively indicating a time spot when the first frame or the second frame is generated.

11. The electronic apparatus of claim 10, wherein in response to the first camera is triggered to capture a first image, the latest one of the first frames recorded with the latest timestamp in the first queue is dumped as the first image.

12. The electronic apparatus of claim 10, wherein the corresponding one of the second frames is recorded with the second timestamp most adjacent to the first timestamp.

13. The electronic apparatus of claim 9, wherein the second image captured by the second camera is paired with the first image captured by the first camera in time-synchronization.

14. The electronic apparatus of claim 9, wherein each of the first queue and the second queue is a ring buffer having a plurality of slots, each of the slots holds one of the first frames or the second frames.

15. The electronic apparatus of claim 9, wherein the first camera is a main camera in a dual camera configuration and the second camera is a subordinate camera in the dual camera configuration.

16. The electronic apparatus of claim 9, wherein the first camera and the second camera utilize asynchronous frame rates respectively for sensing the first frames and the second frames.
